(19) United States
(12) Patent Application Publication
(10) Pub. No.: US 2026/0179328 A1
(43) Pub. Date: Jun. 25, 2026

(54) INFORMATION PROCESSING APPARATUS, INFORMATION PROCESSING SYSTEM, INFORMATION PROCESSING METHOD, AND RECORDING MEDIUM

(71) Applicant: Yuuki SUZUKI, Kanagawa (JP)

(72) Inventor: Yuuki SUZUKI, Kanagawa (JP)

(21) Appl. No.: 19/415,809

(22) Filed: Dec. 11, 2025

(30) Foreign Application Priority Data
Dec. 25, 2024 (JP) 2024-229359

(51) Int. Cl. G06T 19/00; G06T 1/20

(52) U.S. Cl. CPC G06T 19/00; G06T 1/20

(57) ABSTRACT

An information processing apparatus includes circuitry. The circuitry creates a display screen including a first display area that displays a two-dimensional image aligned with three-dimensional information and a second display area that displays information regarding an item, associates the information regarding the item displayed in the second display area with position information indicating a three-dimensional position of the item in the three-dimensional information, the three-dimensional position corresponding to a two-dimensional position specified on the two-dimensional image, and stores, in a memory, the information regarding the item and the position information associated with each other.

### CROSS-REFERENCE TO RELATED APPLICATIONS

This patent application is based on and claims priority pursuant to 35 U.S.C. § 119(a) to Japanese Patent Application No. 2024-229359, filed on Dec. 25, 2024, in the Japan Patent Office, the entire disclosure of which is hereby incorporated by reference herein.

### BACKGROUND

### Technical Field

Embodiments of the present disclosure relate to an information processing apparatus, an information processing system, an information processing method, and a recording medium.

### Related Art

A digital twin technique is known that obtains three-dimensional information of a real-world space as digital data using, for example, a laser scanner, light detection and ranging (LiDAR), or photogrammetry, and reproduces the three-dimensional information on a computer. In recent years, the obtained digital data has been used for, for example, the management of equipment in a building and the management of design information in construction.

### SUMMARY

The present disclosure described herein provides an information processing apparatus including circuitry. The circuitry creates a display screen including a first display area that displays a two-dimensional image aligned with three-dimensional information and a second display area that displays information regarding an item, associates the information regarding the item displayed in the second display area with position information indicating a three-dimensional position of the item in the three-dimensional information, the three-dimensional position corresponding to a two-dimensional position specified on the two-dimensional image, and stores, in a memory, the information regarding the item and the position information associated with each other.

The present disclosure described herein provides an information processing system including the above-described information processing apparatus, and a terminal apparatus communicably connected with the information processing apparatus.

The present disclosure described herein provides an information processing system including circuitry and a memory. The circuitry creates a display screen including a first display area that displays a two-dimensional image aligned with three-dimensional information and a second display area that displays information regarding an item, and associates the information regarding the item displayed in the second display area with position information indicating a three-dimensional position of the item in the three-dimensional information. The three-dimensional position corresponds to a two-dimensional position specified on the two-dimensional image. The memory stores the information regarding the item and the position information associated with each other.

The present disclosure described herein provides an information processing method including creating a display screen including a first display area that displays a two-dimensional image aligned with three-dimensional information and a second display area that displays information regarding an item, associating the information regarding the item displayed in the second display area with position information indicating a three-dimensional position of the item in the three-dimensional information, the three-dimensional position corresponding to a two-dimensional position specified on the two-dimensional image, and storing, in a memory, the information regarding the item and the position information associated with each other.

The present disclosure described herein provides a non-transitory recording medium storing a plurality of instructions which, when executed by one or more processors, causes the one or more processors to perform an information processing method. The information processing method includes creating a display screen including a first display area that displays a two-dimensional image aligned with three-dimensional information and a second display area that displays information regarding an item, associating the information regarding the item displayed in the second display area with position information indicating a three-dimensional position of the item in the three-dimensional information, the three-dimensional position corresponding to a two-dimensional position specified on the two-dimensional image, and storing, in a memory, the information regarding the item and the position information associated with each other.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example configuration of an information processing system;

FIG. 2 is a diagram illustrating an example hardware configuration of a terminal apparatus and a management server;

FIG. 3 is a block diagram illustrating an example functional configuration of the information processing system according to a first embodiment;

FIG. 4 is a view of an example display screen of a three-dimensional (3D) viewer;

FIG. 5 is a view of another example display screen of the 3D viewer;

FIG. 6 is a table illustrating an example of equipment information;

FIG. 7 is a view of an example of a display screen;

FIG. 8 is a view of another example of the display screen;

FIG. 9 is a view of still another example of the display screen;

FIG. 10 is a view of yet another example of the display screen;

FIG. 11 is a table illustrating another example of the equipment information;

FIG. 12 is a flowchart illustrating an example of an association process according to the first embodiment;

FIG. 13 is a block diagram illustrating an example functional configuration of the information processing system according to a second embodiment;

FIG. 14 is a view of yet another example of the display screen; and

FIG. 15 is a flowchart illustrating an example of the association process according to the second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### First Embodiment

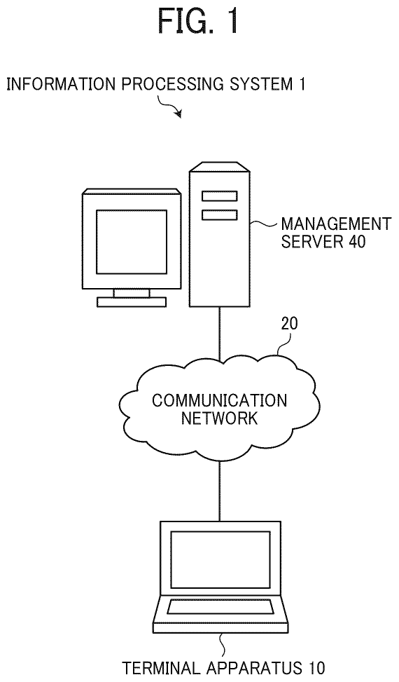

FIG. 1 is a diagram illustrating an example configuration of an information processing system 1. The information processing system 1 includes a terminal apparatus 10 and a management server 40.

The management server 40 is an example of an information processing apparatus that performs one or more information processing operations on three-dimensional information such as a three-dimensional point cloud or a mesh object.

A three-dimensional point cloud is a collection of points defined by X, Y, and Z coordinates (coordinate points) that correspond to measurement points on a surface of an object. The measurement points are obtained by, for example, a laser scanner (LS) measuring a space including the object. Each coordinate point is expressed as (X, Y, Z) such as (1, 3, 5). Each coordinate point may include color information. The color information may be represented by a red-green-blue (RGB) value corresponding to the color components of each coordinate point.

A three-dimensional point cloud may also be referred to as a point cloud. Point cloud data is a collection of coordinate points representing a three-dimensional point cloud in a virtual three-dimensional space and is processed by, for example, a computer.

In the example described above, an LS is used for the measurement of a space to obtain a three-dimensional point cloud. In another example, another optical measuring means or mechanical measuring means may be used. Examples of the optical measuring means include a method using a stereo camera and a method using visual simultaneous localization and mapping (SLAM).

The three-dimensional information may include a digital model (three-dimensional model) of a building or equipment inside a building used in building information modeling (BIM), or a three-dimensional computer-aided design (3D-CAD) model. In addition, equipment (e.g., a device, an instrument, or an apparatus) is an example of an item.

The terminal apparatus 10 and the management server 40 communicate with each other via a communication network 20. The communication network 20 includes, for example, the Internet, a mobile communication network, and a local area network (LAN). The communication network 20 may include not only wired communication networks but also wireless communication networks such as third generation (3G), fifth generation (5G), worldwide interoperability for microwave access (WiMAX), and long-term evolution (LTE) networks. Further, the terminal apparatus 10 may perform communication using a short-range communication technology such as near-field communication (NFC™).

### Hardware Configuration

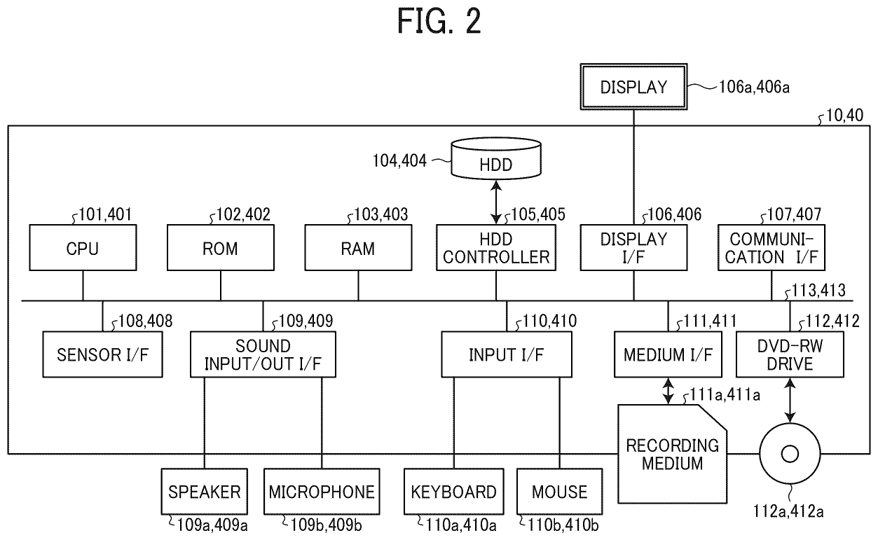

FIG. 2 is a diagram illustrating an example hardware configuration of the terminal apparatus 10 and the management server 40. Hardware components of the terminal apparatus 10 are indicated by reference numerals in the 100 series. Hardware components of the management server 40 are indicated by reference numerals in the 400 series.

The terminal apparatus 10 includes a central processing unit (CPU) 101, a read-only memory (ROM) 102, a random-access memory (RAM) 103, a hard disk drive (HDD) 104, an HDD controller 105, a display interface (I/F) 106, a communication I/F 107, a sensor I/F 108, a sound input/output I/F 109, an input I/F 110, a medium I/F 111, a digital versatile disk-rewritable (DVD-RW) drive 112, and a bus line 113.

The CPU 101 controls the operation of the terminal apparatus 10. The ROM 102 stores, for example, programs for executing the CPU 101. The RAM 103 is, for example, used as a work area for the CPU 101. The HDD 104 stores, for example, various data such as programs. The HDD controller 105 controls, for example, the reading and writing of various data from and to the HDD 104 under the control of the CPU 101.

The display I/F 106 is an interface for connecting a display 106a, which displays various types of information such as a cursor, menus, windows, characters, and images. The communication I/F 107 is an interface for data communication using the communication network 20. The sensor I/F 108 is an interface for connecting various sensors to the terminal apparatus 10.

The sound input/output I/F 109 is an interface for connecting a speaker 109a and a microphone 109b to the terminal apparatus 10. The input I/F 110 is an interface for connecting input devices such as a keyboard 110a and a mouse 110b to the terminal apparatus 10. The keyboard 110a is an example of an input device including a plurality of keys for inputting, for example, characters, numerical values, and various instructions. The mouse 110b is an example of an input device that allows a user to select or execute various instructions, select a target to be processed, and move a cursor being displayed.

The medium I/F 111 controls the reading and writing (storing) of data from and to a recording medium 111a such as a flash memory.

The DVD-RW drive 112 controls the reading and writing of various data from and to a DVD-RW 112a, which is an example of a removable recording medium. The terminal apparatus 10 may further have a configuration for controlling reading and writing (storage) of data from and to an external personal computer (PC) or an external device which is external to the terminal apparatus 10 and connected through wired communication or wireless communication such as wireless fidelity (Wi-Fi™).

The management server 40 includes a CPU 401, a ROM 402, a RAM 403, an HDD 404, an HDD controller 405, a display I/F 406, a communication I/F 407, a sensor I/F 408, a sound input/output I/F 409, an input I/F 410, a medium I/F 411, a DVD-RW drive 412, and a bus line 413. Since these components have the same or substantially the same configurations as the above-described components (the CPU 101, the ROM 102, the RAM 103, the HDD 104, the HDD controller 105, the display I/F 106, the communication I/F 107, the sensor I/F 108, the sound input/output I/F 109, the input I/F 110, the medium I/F 111, the DVD-RW drive 112, and the bus line 113), the descriptions of these components are omitted. As with the terminal apparatus 10, devices such as a display 406a, a speaker 409a, a microphone 409b, a keyboard 410a, a mouse 410b, and a recording medium 411a are connected to the management server 40 via their respective interfaces such as the display I/F 406, the sound input/output I/F 409, the input I/F 410, and the medium I/F 411.

The terminal apparatus 10 and the management server 40 may include a digital versatile disc recordable (DVD-R) drive, instead of the DVD-RW drive 112 or 412. In one embodiment, each of the terminal apparatus 10 and the management server 40 may be implemented by a single computer. In another embodiment, each of the terminal apparatus 10 and the management server 40 may be implemented by a plurality of computers to which its components (functions, means, and storage units) are divided and allocated as desired.

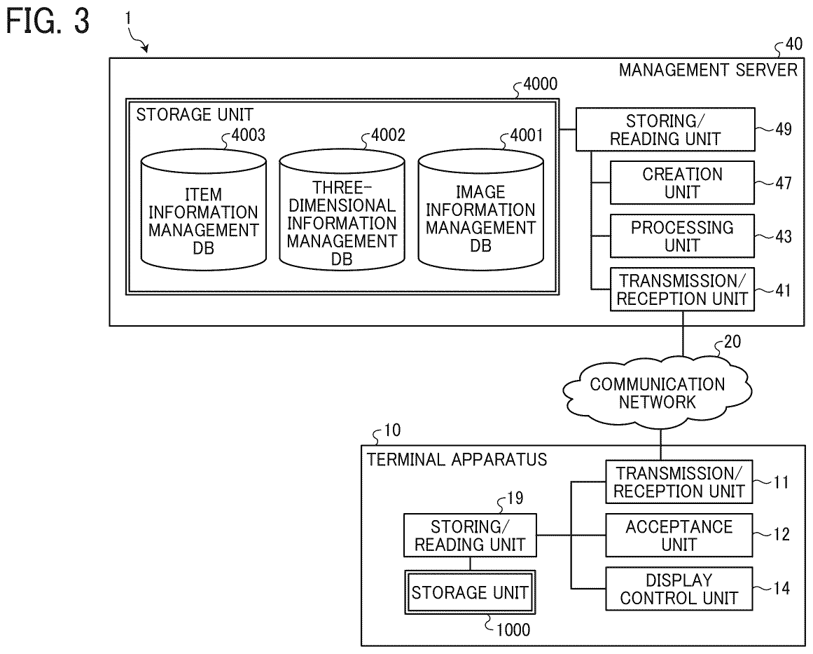

FIG. 3 is a block diagram illustrating an example functional configuration of the information processing system 1 according to the first embodiment.

### Functional Configuration of Terminal Apparatus

As illustrated in FIG. 3, the terminal apparatus 10 includes a transmission/reception unit 11, an acceptance unit 12, a display control unit 14, and a storing/reading unit 19. Each of these units is a function or means that is implemented by or caused to function by one or more of the hardware components illustrated in FIG. 2 operating in accordance with instructions from the CPU 101 according to a program loaded from the HDD 104 to the RAM 103. The terminal apparatus 10 also includes a storage unit 1000, which is implemented by the RAM 103 and the HDD 104 illustrated in FIG. 2.

### Functional Configuration of Terminal Apparatus

The functional units of the terminal apparatus 10 are described below.

The transmission/reception unit 11 is an example of a transmission/reception unit. The transmission/reception unit 11 is implemented by the communication I/F 107 and instructions from the CPU 101 illustrated in FIG. 2. The transmission/reception unit 11 transmits and receives various data (or information) to and from other apparatuses, terminal apparatuses, or systems via the communication network 20.

The acceptance unit 12 is an example of an acceptance unit. The acceptance unit 12 is implemented by, for example, instructions from the CPU 101, the keyboard 110a, and the mouse 110b illustrated in FIG. 2. The acceptance unit 12 receives various inputs from a user.

The display control unit 14 is an example of a display control unit. The display control unit 14 is implemented by instructions from the CPU 101 illustrated in FIG. 2. The display control unit 14 displays various images and screens on the display 106a, which is an example of a display.

The terminal apparatus 10 displays three-dimensional information using an application such as a three-dimensional (3D) viewer that visualizes the three-dimensional information. The 3D viewer is, for example, a web application used in a web browser, a PC application running on a PC, or a smartphone application running on a smartphone.

The three-dimensional information may be information uploaded to a cloud service or stored on a device of the terminal apparatus 10, which is, for example, a PC or a smartphone. The terminal apparatus 10 visualizes the three-dimensional information on a 3D viewer regardless of the type of 3D viewer or the location where the three-dimensional information is stored. As long as the three-dimensional information is dividable into components, the three-dimensional information may be in any data format such as a mesh or a point cloud.

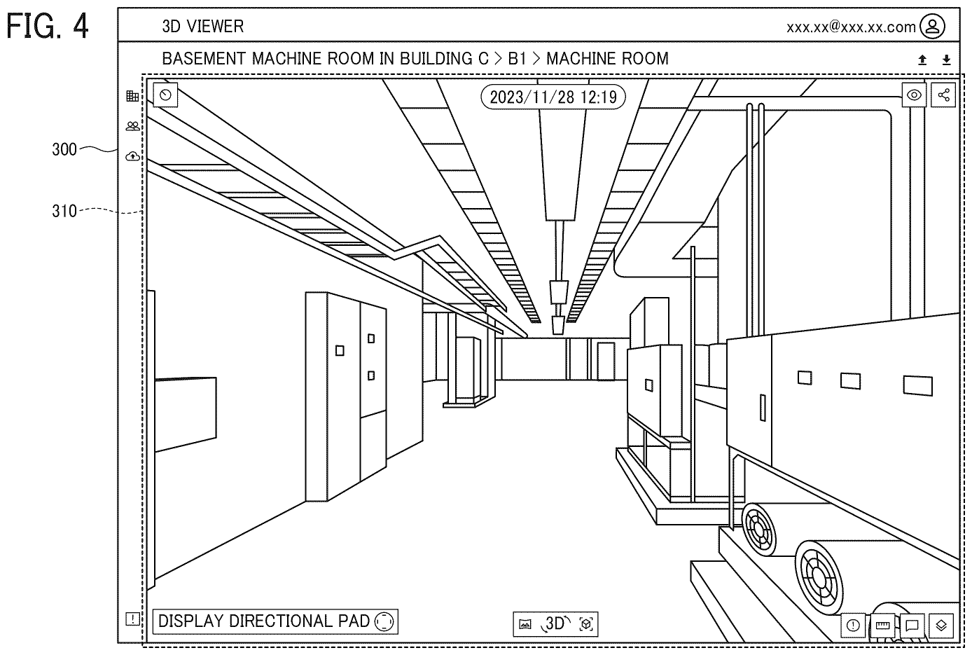

FIG. 4 is a view of an example display screen of the 3D viewer. The information processing system 1 visualizes the three-dimensional information to reproduce a real-world space using the 3D viewer based on the image information and the three-dimensional information obtained by capturing the real-world space in advance. In this way, the information processing system 1 implements a digital twin. FIG. 4 illustrates a display screen 300, which includes a first display area 310. The first display area 310 displays a two-dimensional image (desired viewpoint image) depicting the interior of a machine room from a certain viewpoint.

The image information according to the present embodiment is information regarding a two-dimensional image (e.g., a full-sphere image, an image such as a photograph, or a texture image generated from a photograph) that is aligned with the three-dimensional information. The two-dimensional image is aligned with the three-dimensional information by, for example, embedding the coordinate values of the three-dimensional information into each pixel as metadata. Therefore, specifying a pixel at a particular two-dimensional position on the two-dimensional image determines a three-dimensional position in the three-dimensional information corresponding to the specified two-dimensional position.

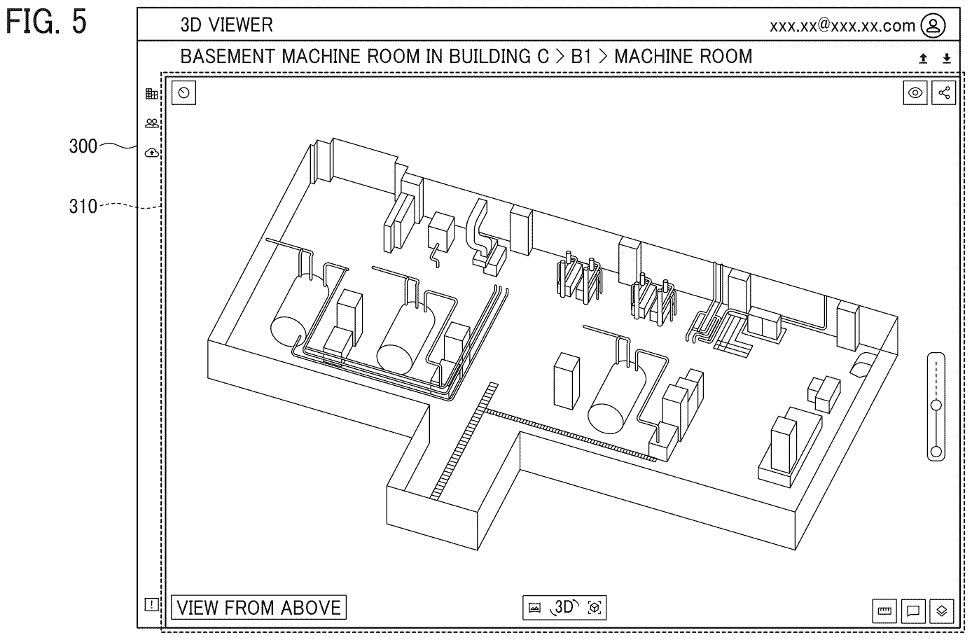

FIG. 5 is a view of another example display screen of the 3D viewer. In this example, the first display area 310 displays a two-dimensional image (overhead image) depicting an overhead view of the entire machine room illustrated in FIG. 4. When the user views the visualized three-dimensional information, the user may switch between the desired viewpoint image illustrated in FIG. 4 and the overhead image illustrated in FIG. 5. The user may check the contents of the three-dimensional information from various angles and viewpoints by changing the viewpoint of the desired viewpoint image or the angle of the overhead image through an input operation with the acceptance unit 12. In this way, the 3D viewer enables the user to display and check an image or an overhead image of a desired captured place inside the building and walk through the three-dimensional space.

The storing/reading unit 19 is an example of a storage control unit. The storing/reading unit 19 is implemented by the HDD controller 105, the medium I/F 111, the DVD-RW drive 112, instructions from the CPU 101 illustrated in FIG. 2, and an external PC or an external device which is external to the terminal apparatus 10. The storing/reading unit 19 stores various data in the storage unit 1000, the recording medium 111a, the DVD-RW 112a, the external PC, or the external device. The storing/reading unit 19 reads various data from the storage unit 1000, the recording medium 111a, the DVD-RW 112a, the external PC, or the external device. The storage unit 1000, the recording medium 111a, the DVD-RW 112a, the external PC, and the external device are examples of a storage unit.

### Functional Configuration of Management Server

As illustrated in FIG. 3, the management server 40 includes a transmission/reception unit 41, a processing unit 43, a creation unit 47, and a storing/reading unit 49. Each of these units is a function or means that is implemented by or caused to function by one or more of the hardware components illustrated in FIG. 2 operating in accordance with instructions from the CPU 401 according to a program loaded from the HDD 404 to the RAM 403. The management server 40 also includes a storage unit 4000, which is implemented by the HDD 404 illustrated in FIG. 2. The storage unit 4000 is an example of a storage unit.

### Functional Configuration of Management Server

The functional units of the management server 40 are described below. The management server 40 may be implemented by a plurality of computers to which the functional units of the management server 40 are divided and allocated. In the present embodiment, the management server 40 is a server computer residing in a cloud environment. In another embodiment, the management server 40 may be a server residing in an on-premises environment.

The transmission/reception unit 41 is an example of a transmission/reception unit. The transmission/reception unit 41 is implemented by the communication I/F 407 and instructions from the CPU 401 illustrated in FIG. 2. The transmission/reception unit 41 transmits and receives various data (or information) to and from other apparatuses, terminal apparatuses, or systems via the communication network 20.

The transmission/reception unit 41 receives equipment information. The received equipment information is stored in an item information management database (DB) 4003 via the storing/reading unit 49. The equipment information herein refers to information regarding equipment inside a building. The equipment information includes information regarding, for example, the equipment identification (ID), the place where the equipment is installed, the equipment name, and the maintenance schedule. The equipment information is an example of information regarding an item.

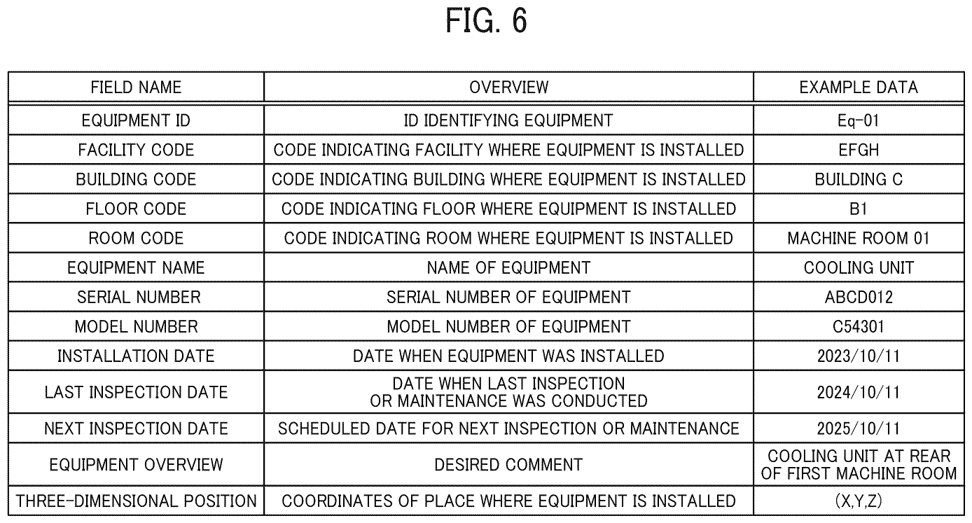

FIG. 6 illustrates an example of the equipment information. As illustrated in FIG. 6, the equipment information includes various types of information regarding equipment (e.g., the equipment ID, the room code, the equipment name, and the inspection date). A building includes numerous pieces of equipment subjected to statutory inspection and scheduled maintenance. The “last inspection date” information and the “next inspection date” information in FIG. 6 are used to manage the inspection and maintenance schedule for each equipment.

The “three-dimensional position” in FIG. 6 indicates the coordinates of the place (position information) where the equipment is installed. The three-dimensional position is expressed in, for example, the (X, Y, Z) format. The user refers to this information to figure out the place where the equipment scheduled for maintenance is installed. In the present embodiment, the management server 40 facilitates the specification and storage of the position information of each of numerous pieces of equipment in the building, enabling the management of each equipment in the building.

The equipment information may be generated on the management server 40. For example, an administrator may add or edit the equipment information by operating the keyboard 410a or the mouse 410b. The storing/reading unit 49 stores the added or edited equipment information in the item information management DB 4003. The equipment information may be in any file format, as long as the file format allows for the description of information in each field. Examples of the file format include Microsoft Excel formats and comma-separated values (CSV) formats.

The transmission/reception unit 41 may receive equipment information in a file format. Alternatively, the transmission/reception unit 41 may receive the equipment information via an application programming interface (API) from a database included in an external system external to the information processing system 1. The field names of the equipment information illustrated in FIG. 6 are merely examples. The equipment information may include different fields depending on the conditions of the building where the equipment is installed.

The processing unit 43 is implemented by instructions from the CPU 401 illustrated in FIG. 2. The processing unit 43 performs various processes, including a process of associating the position information with the equipment information. The association process is described later.

The creation unit 47 is implemented by instructions from the CPU 401 illustrated in FIG. 2. The creation unit 47 creates the display screen 300 to be displayed on, for example, the 3D viewer.

The storing/reading unit 49 is an example of a storage control unit. The storing/reading unit 49 is implemented by the HDD controller 405, the medium I/F 411, the DVD-RW drive 412, instructions from the CPU 401 illustrated in FIG. 2, and an external PC or an external device which is external to the management server 40. The storing/reading unit 49 stores various data in the storage unit 4000, the recording medium 411a, the DVD-RW 412a, the external PC, or the external device. The storing/reading unit 49 reads various data from the storage unit 4000, the recording medium 411a, the DVD-RW 412a, the external PC, or the external device. The storage unit 4000, the recording medium 411a, the DVD-RW 412a, the external PC, and the external device are examples of the storage unit.

The storage unit 4000 includes an image information management DB 4001, a three-dimensional information management DB 4002, and the item information management DB 4003. The storage unit 4000 may be implemented by a plurality of servers. For example, in a case where the storage unit 4000 is implemented by a first server and a second server, the first server may include the image information management DB 4001 and the three-dimensional information management DB 4002, and the second server may include the item information management DB 4003.

The image information management DB 4001 stores and manages image information. The three-dimensional information management DB 4002 stores and manages three-dimensional information. The item information management DB 4003 stores and manages equipment information (information regarding an item).

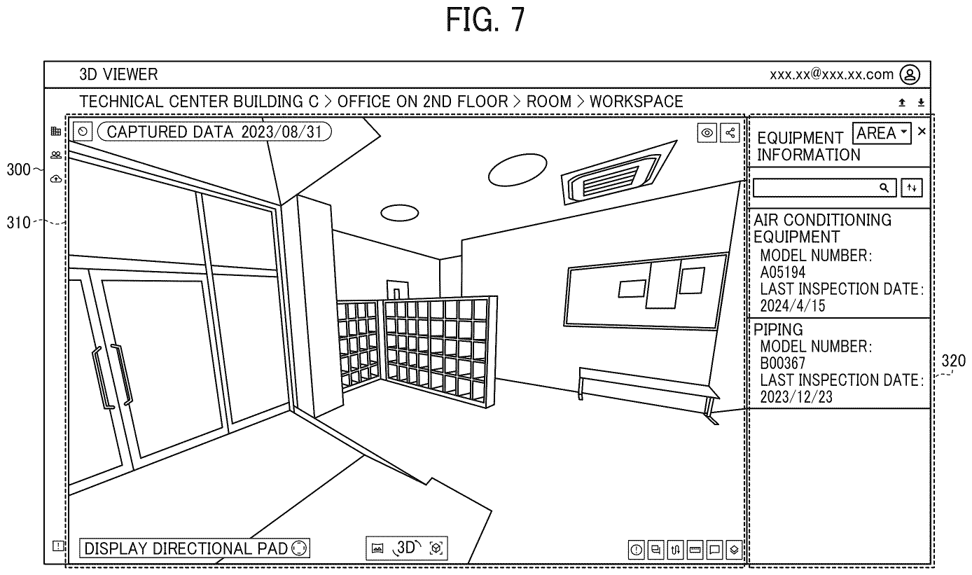

The screens created by the creation unit 47 and the association process performed by the processing unit 43 are described with reference to FIGS. 7 to 12.

FIG. 7 is a view of an example of the display screen 300 created by the creation unit 47. The display screen 300 in FIG. 7 includes the first display area 310 and a second display area 320. The first display area 310 displays a two-dimensional image aligned with three-dimensional information. The second display area 320 displays equipment information. For example, while the user views the two-dimensional image on the first display area 310 illustrated in FIG. 4 or 5, the user may select a function for displaying the equipment information on the 3D viewer so that the second display area 320 is added to the display screen 300. The first display area 310 is an example of a first display area, and the second display area 320 is an example of a second display area.

The second display area 320 illustrated in FIG. 7 displays the equipment name, the model number, and the last inspection date among pieces of information included in each equipment information. By limiting the number of fields displayed, the second display area 320 displays equipment information for a plurality of pieces of equipment.

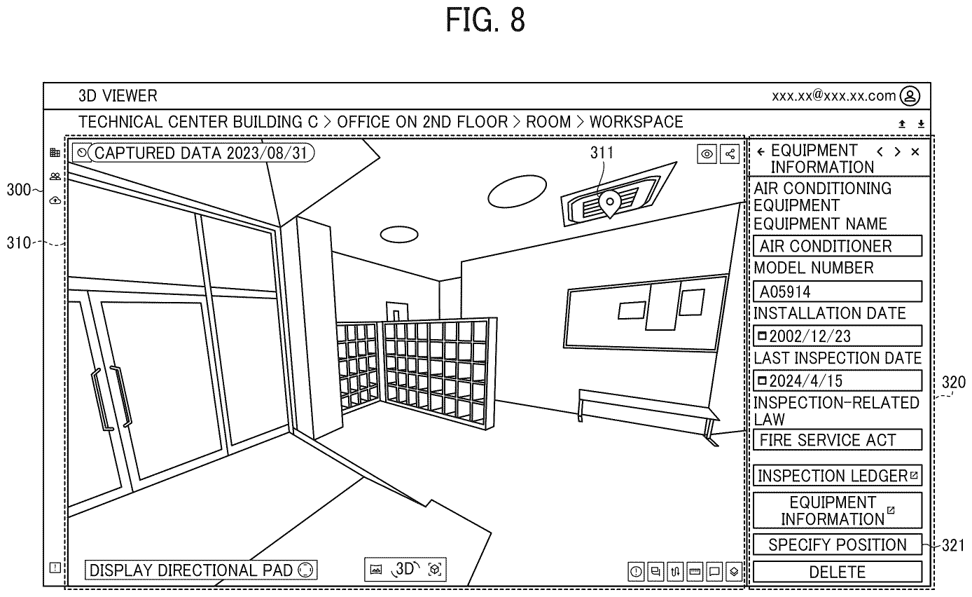

FIG. 8 is a view of another example of the display screen 300 created by the creation unit 47. The difference from FIG. 7 is that the second display area 320 displays the equipment information of the equipment selected from the plurality of pieces of equipment, with additional fields. Specifically, the user selects desired equipment from the plurality of pieces of equipment displayed on the second display area 320 of FIG. 7. In response, the second display area 320 displays the equipment information of the selected equipment.

In FIG. 8, the second display area 320 displays additional fields such as the installation date and an inspection-related law (the name of the law serving as the basis for the inspection). The user may edit the contents of each field displayed in the second display area 320.

The second display area 320 illustrated in FIG. 8 displays a position specification button 321. In a case where the position information has not been associated with the equipment information of the selected equipment, the second display area 320 displays the position specification button 321. For example, in a case where the equipment information is information received from a spreadsheet or equipment ledger management software, the equipment information is not associated with the position information. That is, the equipment information does not include information regarding the “three-dimensional position.” In this case, in the present embodiment, the position information is associated with the equipment information as described below.

The user presses the position specification button 321 with, for example, the mouse 110b, to display a position pointer 311 on the first display area 310. The user may move the position pointer 311 to a desired two-dimensional position and then press the position specification button 321 to specify the two-dimensional position.

The processing unit 43 associates the equipment information with the position information indicating the three-dimensional position of the equipment in the three-dimensional information. The three-dimensional position corresponds to the specified two-dimensional position. The storing/reading unit 49 stores, in the storage unit 4000, the equipment information and the position information, which have been associated with each other by the processing unit 43. Accordingly, the storage unit 4000 stores, as associated information, the coordinates of the place where the equipment is installed, which is the three-dimensional position of the equipment added to the equipment information, the equipment information written into data at the position indicated by the position information in the three-dimensional information, and link information including a link to the file of the equipment information written into the data.

In a case where the equipment information of the selected equipment has been associated with the position information, the creation unit 47 creates the display screen 300 that displays, in the first display area 310, a two-dimensional image of a place surrounding the two-dimensional position corresponding to the position information. This allows the user to view the image of the selected equipment and its surroundings. In this case, the second display area 320 may display a position change button, instead of the position specification button 321. The user may press the position change button to display the position pointer 311, move the position pointer 311 to a desired position, and press the position change button again to change (edit) the position information.

In a case where the equipment information has not been associated with the position information, the creation unit 47 may create the display screen 300 that displays, in the first display area 310, a two-dimensional image of an area including the place where the equipment is installed based on information such as the room code included in the equipment information. This allows the user to easily specify the two-dimensional position of the equipment. The information such as the room code is stored in the three-dimensional information when, for example, the three-dimensional information is captured.

In a case where the equipment information has not been associated with the position information and does not include information such as the room code, the processing unit 43 may add a room code indicating the room including the two-dimensional position specified by the user to the equipment information, while performing the association process. This configuration allows the user to add the room code to the equipment information by specifying the two-dimensional position of the equipment.

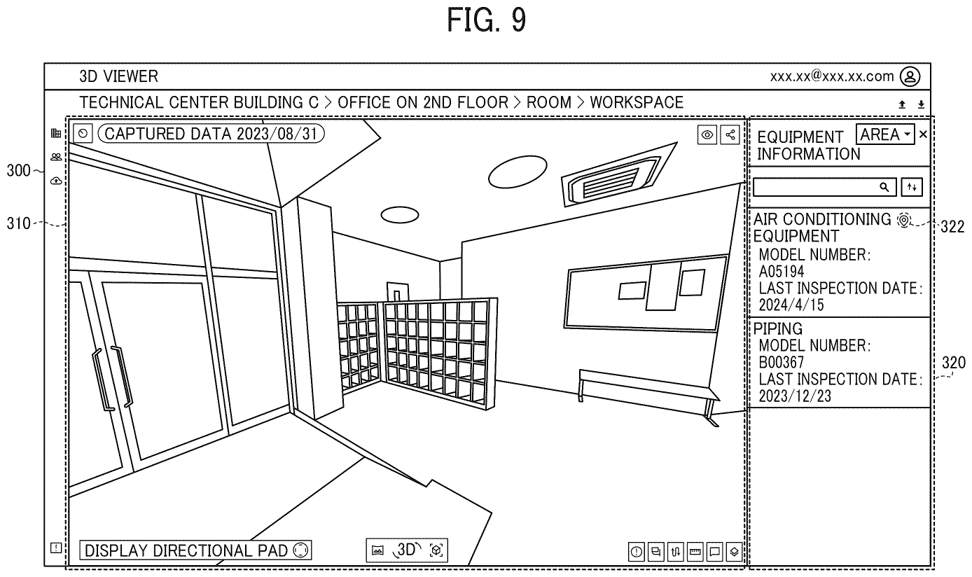

FIG. 9 is a view of still another example of the display screen 300 created by the creation unit 47. The difference from FIG. 7 is that a position icon 322 is displayed together with the corresponding equipment information displayed in the second display area 320. The position icon 322 indicates that the equipment information has been associated with the position information indicating the three-dimensional position of the equipment in the three-dimensional information. In the example illustrated in FIG. 9, the position icon 322 is displayed together with the equipment information of air conditioning equipment, indicating that the equipment information of the air conditioning equipment has been associated with the position information. On the other hand, the position icon 322 is not displayed for the equipment information of piping, indicating that the equipment information of the piping has not been associated with the position information.

In this way, the presence or absence of the position icon 322 allows the user to easily recognize whether the equipment information has been associated with the position information. The position icon 322 is an example of an identification image indicating that the position information and the equipment information have been associated with each other.

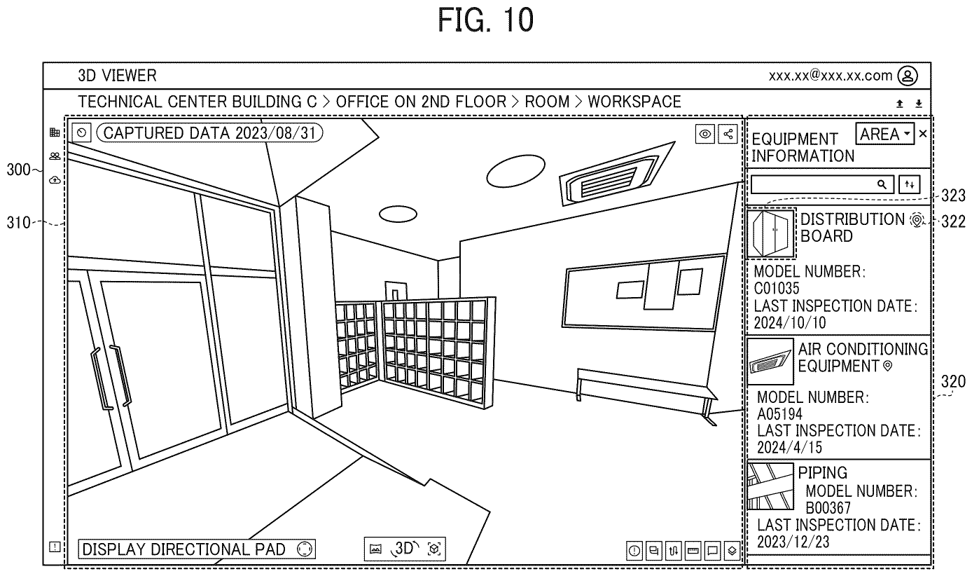

FIG. 10 is a view of yet another example of the display screen 300 created by the creation unit 47. The difference from FIG. 9 is that a thumbnail image 323 is displayed together with each equipment information displayed in the second display area 320. The processing unit 43 extracts a portion of a two-dimensional image at a two-dimensional position specified by the user and associates the extracted portion with the equipment information. The creation unit 47 displays, in the second display area 320, the extracted portion (hereinafter referred to as “partial image”) as the thumbnail image 323.

For the equipment information that has not been associated with the position information, the processing unit 43 displays, in the second display area 320, an image prepared in advance for the equipment as the thumbnail image 323. In this case, the thumbnail image 323 may be a character image including the equipment name, an icon image schematically representing the equipment, or an icon image including a typical photograph of the equipment.

The area from which the processing unit 43 extracts a partial image from the two-dimensional image may be either a predefined area including a two-dimensional position specified by the user or an area selected by the user.

Displaying the thumbnail image 323 in this way allows the user to easily select desired equipment from the second display area 320. The thumbnail image 323 is an example of a partial image of a two-dimensional image at a two-dimensional position.

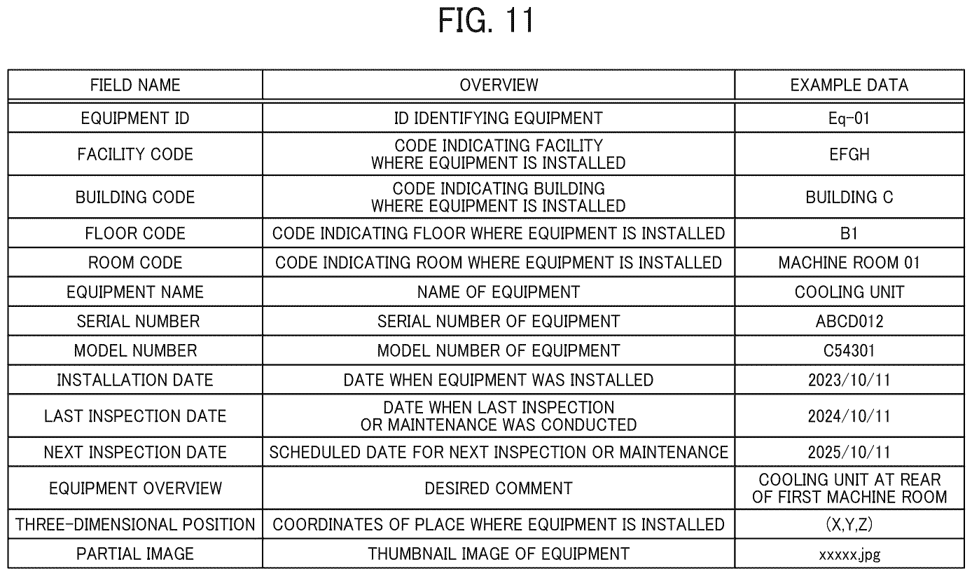

FIG. 11 illustrates another example of the equipment information. The difference from FIG. 6 is that a field “partial image” is added to the equipment information. In the example illustrated in FIG. 11, the field “partial image” includes the filename of a partial image associated with the equipment information. Instead of the filename, the field “partial image” may include link information including a link to the partial image.

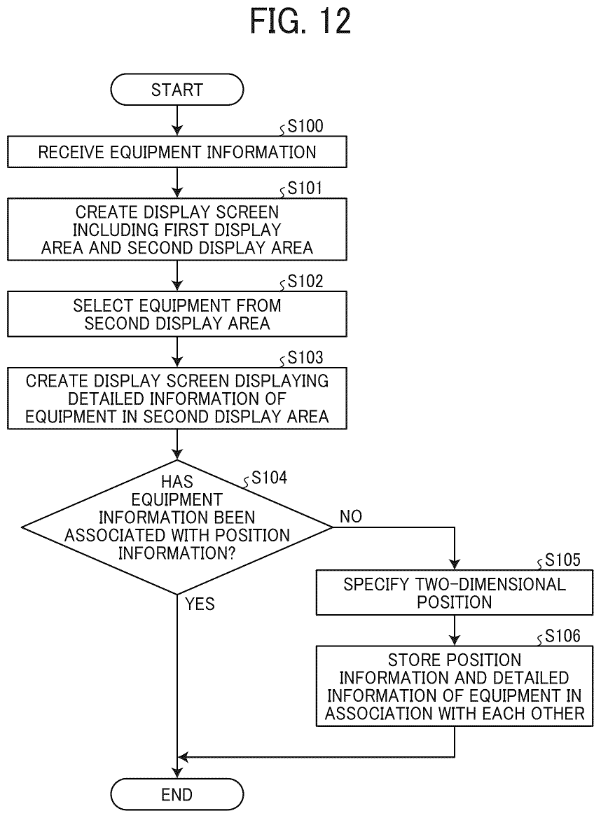

FIG. 12 is a flowchart illustrating an example of the association process according to the first embodiment.

In step S100, the transmission/reception unit 41 receives one or more pieces of equipment information. In step S101, the creation unit 47 creates the display screen 300, which includes the first display area 310 and the second display area 320. At this time, the one or more pieces of equipment information received by the transmission/reception unit 41 are displayed in the second display area 320. The display control unit 14 displays the created display screen 300 on the display 106a. In the following steps as well, when the creation unit 47 creates the display screen 300, the display control unit 14 displays the created display screen 300 on the display 106a.

In step S102, the transmission/reception unit 41 receives a selection of desired equipment from the second display area 320 from the user, for example, via the acceptance unit 12 and the transmission/reception unit 11. In step S103, the creation unit 47 creates the display screen 300 that displays the detailed information of the selected equipment in the second display area 320.

In step S104, the processing unit 43 determines whether the selected equipment information has been associated with the position information. In a case where the selected equipment information has been associated with the position information (Yes in step S104), the association process ends. In a case where the selected equipment information has not been associated with the position information (No in step S104), the operation proceeds so that the user specifies the two-dimensional position of the equipment in step S105. Specifically, in the case where the selected equipment information has not been associated with the position information, in one example, the processing unit 43 does not display the position icon 322. The user specifies the two-dimensional position by pressing the position specification button 321 to display the position pointer 311, moving the position pointer 311 to a desired position, and then pressing the position specification button 321 again. Accordingly, the transmission/reception unit 41 receives the two-dimensional position specified by the user, for example, via the acceptance unit 12 and the transmission/reception unit 11.

In step S106, the processing unit 43 associates the equipment information with the position information based on the specified two-dimensional position, and the storing/reading unit 49 stores the associated equipment information and position information in, for example, the storage unit 4000.

In another embodiment, the functions of the management server 40 illustrated in FIG. 3 may be integrated into the terminal apparatus 10, and the terminal apparatus 10 may perform the process performed by the management server 40 in the example described above.

According to the present embodiment, since the first display area 310 and the second display area 320 are displayed, the equipment information is easily associated with the position information indicating the three-dimensional position of the equipment in the three-dimensional information.

### Second Embodiment

The information processing system 1 according to a second embodiment displays a candidate two-dimensional position in the first display area 310 based on a pre-trained artificial intelligence (AI) model. The candidate two-dimensional position is a candidate for the two-dimensional position of particular equipment. The following description focuses on the differences from the first embodiment, omitting the description of the configuration and components identical to the configuration and components according to the first embodiment.

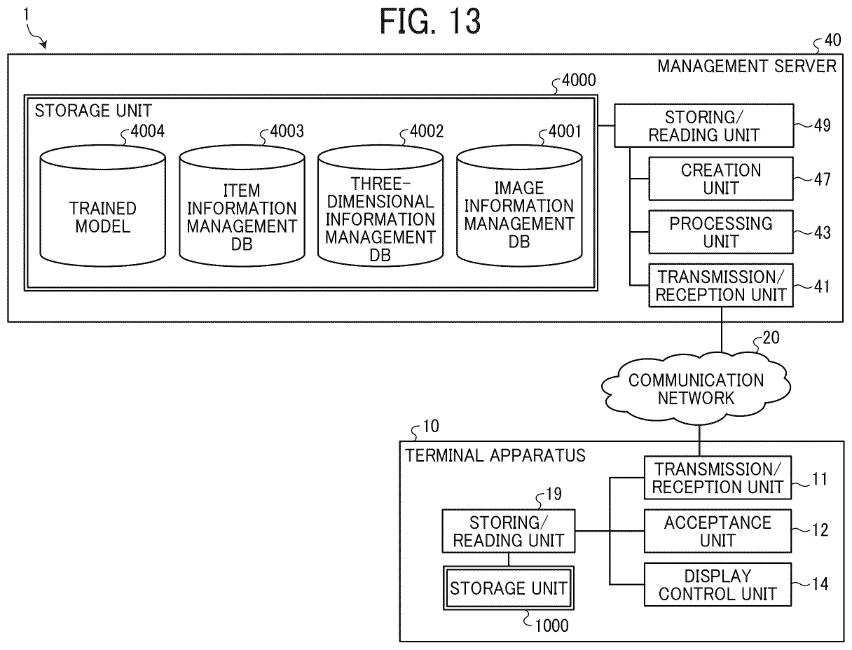

FIG. 13 is a block diagram illustrating an example functional configuration of the information processing system 1 according to the second embodiment. The difference from FIG. 3 is that the storage unit 4000 of the management server 40 additionally includes a trained model 4004. In a case where the storage unit 4000 is implemented by a plurality of servers, any of the servers may include the trained model 4004. For example, in a case where the storage unit 4000 is implemented by a first server and a second server, either the first server or the second server may include the trained model 4004.

The trained model 4004 illustrated in FIG. 13 is an AI model (machine learning model) trained using training data including a plurality of pieces of equipment information and a plurality of two-dimensional images. Each two-dimensional image used for machine learning is, for example, an image of equipment indicated by the equipment information.

Machine learning herein refers to a technique that enables a computer to acquire a human-like learning ability. Specifically, machine learning refers to a technique that enables a computer to autonomously generate an algorithm to be used for determination, such as data identification, from training data input to the computer in advance and apply the generated algorithm to new data to make a prediction. Machine learning may employ any learning method such as supervised learning, unsupervised learning, semi-supervised learning, reinforcement learning, deep learning, or any combination of these learning methods.

Based on the trained model 4004 and the equipment information selected by the user in the second display area 320, the processing unit 43 searches the two-dimensional image aligned with the three-dimensional information for an image of the equipment indicated by the equipment information. The processing unit 43 then obtains the position of the searched image as a candidate two-dimensional position.

The creation unit 47 creates the display screen 300 that displays, in the first display area 310, an indication image, which indicates the candidate two-dimensional position obtained by the processing unit 43, on top of the two-dimensional image aligned with the three-dimensional information.

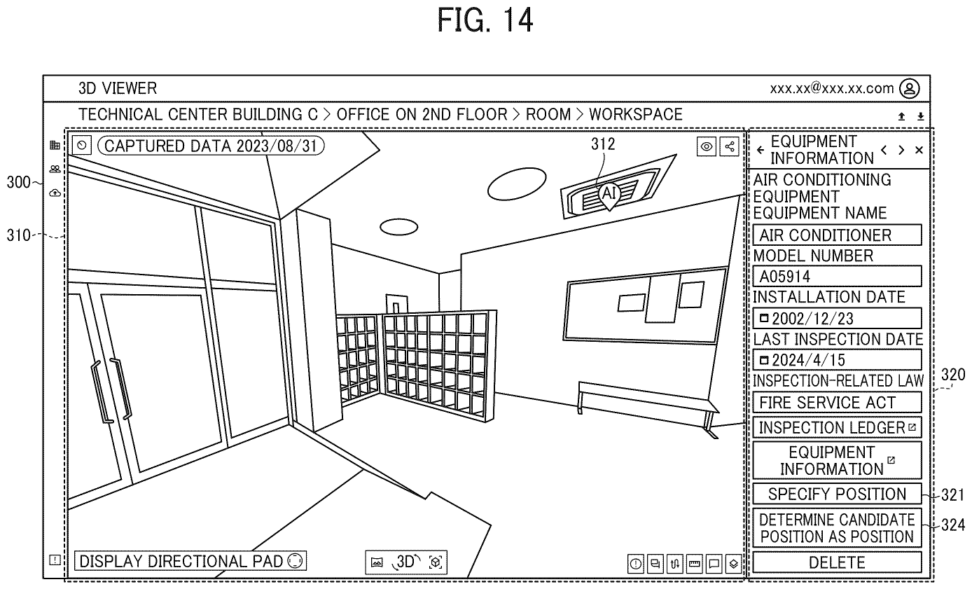

FIG. 14 is a view of yet another example of the display screen 300 created by the creation unit 47. The difference from FIG. 8 is that a candidate pointer 312, which is an example of the indication image indicating a candidate two-dimensional position, is displayed in the first display area 310, and a candidate position determination button 324 is additionally displayed in the second display area 320.

The user checks the position of the candidate pointer 312 and presses the candidate position determination button 324 to determine the position of the candidate pointer 312 as the two-dimensional position of the equipment displayed in the second display area 320. In the present embodiment, the two-dimensional position of the equipment is determined based on the trained model 4004 so that the position information and the equipment information are easily associated with each other.

Further, the user may move the position of the candidate pointer 312 to a desired position and press the position specification button 321 to specify the desired position as the two-dimensional position. This configuration allows the user to easily modify the two-dimensional position obtained based on the trained model 4004.

In some embodiments, the candidate position determination button 324 may not be displayed in the second display area 320. In this case, the processing unit 43 may associate the position information with the equipment information using the two-dimensional position obtained based on the trained model 4004. Even in this case, the user may move the position of the candidate pointer 312 to a desired position and press the position specification button 321 to specify the desired position as the two-dimensional position.

The training data used for the trained model 4004 may also include three-dimensional information. Training using a plurality of pieces of three-dimensional information and a plurality of two-dimensional images improves the accuracy of the image search.

In the present embodiment, the position icon 322 illustrated in FIG. 9 may also be displayed in the second display area 320. In this case, the image of the position icon 322 indicating that the equipment information has been associated with the position information based on the two-dimensional position specified by the user may be different from the image of the position icon 322 indicating that the equipment information has been associated with the position information based on the two-dimensional position determined based on the trained model 4004. For example, these images may be identification images different in shape or color. Differentiating the identification images in this way allows the user to easily identify which equipment information has been associated with the position information based on the trained model 4004 and check or modify the position information as desired.

The position icon 322 indicating that the equipment information has been associated with the position information based on the two-dimensional position specified by the user is an example of a first identification image. Further, the position icon 322 indicating that the equipment information has been associated with the position information based on the two-dimensional position determined based on the trained model 4004 is an example of a second identification image. Instead of differentiating these images of the position icon 322, the equipment information associated with the position information based on the trained model 4004 may be displayed in the second display area 320 together with, for example, a tag that reads “AI detection result.”

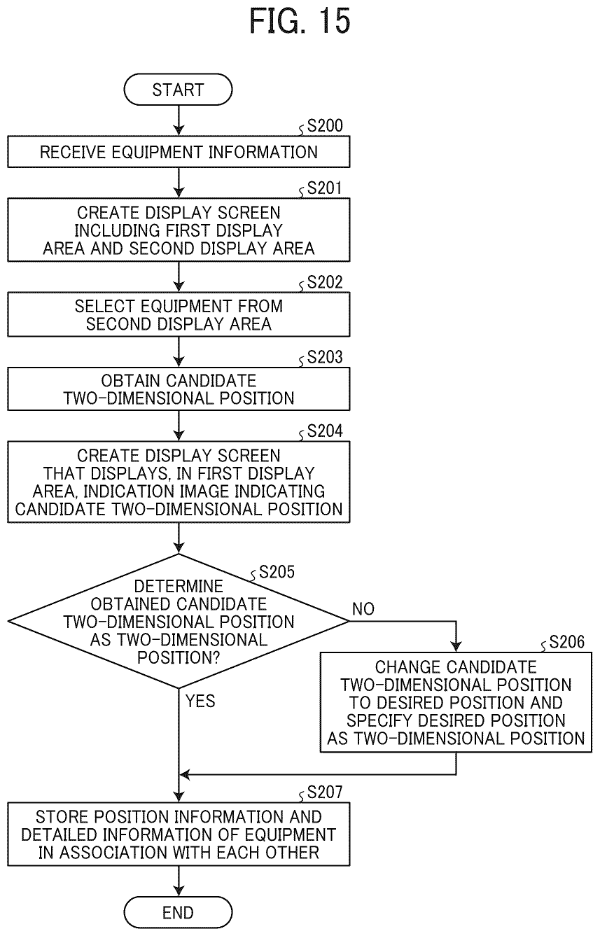

FIG. 15 is a flowchart illustrating an example of the association process according to the second embodiment. Since the processing in steps S200 to S202 and S207 of FIG. 15 is the same or substantially the same as the processing in steps S100 to S102 and S106 of FIG. 12, the description thereof is omitted.

In step S203, the processing unit 43 obtains a candidate two-dimensional position based on the trained model 4004. In step S204, the creation unit 47 creates the display screen 300 that displays, in the first display area 310, an indication image indicating the candidate two-dimensional position.

In step S205, the processing unit 43 determines whether the obtained candidate two-dimensional position is determined as the two-dimensional position of the equipment according to a user input. In a case where the user determines the obtained candidate two-dimensional position as the two-dimensional position of the equipment (Yes in step S205), it is assumed that there is no user input, and the processing proceeds to step S207. In a case where the user does not determine the obtained candidate two-dimensional position as the two-dimensional position of the equipment (No in step S205), the user changes (moves) the candidate two-dimensional position to a desired position and specifies the desired position as the two-dimensional position of the equipment in step S206. Accordingly, the transmission/reception unit 41 receives the two-dimensional position specified by the user, for example, via the acceptance unit 12 and the transmission/reception unit 11.

In this way, determining the two-dimensional position of the equipment based on the trained model 4004 according to the present embodiment reduces the user's burden to specify the two-dimensional position.

The programs executed by the information processing apparatus according to the above-described embodiments are recorded and provided as a file in an installable format or an executable format in any computer-readable recording medium such as a compact-disc read-only memory (CD-ROM), a flexible disk (FD), a compact-disc recordable (CD-R), or a digital versatile disc (DVD).

Further, the programs executed by the information processing apparatus according to the above-described embodiments may be stored on a computer connected to a network such as the Internet and downloaded via the network when provided. Further, the programs executed by the information processing apparatus according to the above-described embodiments may be provided or distributed via a network such as the Internet.

The programs according to the above-described embodiments may be stored in a memory such as a ROM in advance before provided.

The programs executed by the information processing apparatus according to the above-described embodiments have a module configuration including the above-described units such as the processing unit 43, the creation unit 47, and the storing/reading unit 49. The CPU (processor) reads and executes the programs from the above-described recording medium to load the above-described units onto a main memory, thereby generating the above-described units on the main memory to cause the hardware of the information processing apparatus to operate as the above-described units.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The illustrated apparatuses are only illustrative of one of computing environments for implementing the embodiments disclosed herein.

For example, in some embodiments, the management server 40 includes a plurality of computing devices, e.g., a server cluster, that are configured to communicate with each other over any type of communications link, including a network, a shared memory, etc. to collectively perform the processes disclosed herein. Similarly, the terminal apparatus 10 can include a plurality of computing devices that are configured to communicate with each other.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

Aspects of the present disclosure are, for example, as follows.

### Aspect 1

According to Aspect 1, an information processing apparatus includes a creation unit, a processing unit, and a storage control unit. The creation unit creates a display screen including a first display area that displays a two-dimensional image aligned with three-dimensional information and a second display area that displays information regarding an item. The processing unit associates the information regarding the item displayed in the second display area with position information indicating a three-dimensional position of the item in the three-dimensional information. The three-dimensional position corresponds to a two-dimensional position specified on the two-dimensional image. The storage control unit stores, in a storage unit, the information regarding the item and the position information associated with each other by the processing unit.

### Aspect 2

According to Aspect 2, in the information processing apparatus of Aspect 1, the item includes a plurality of items. The creation unit creates the display screen that displays, in the second display area, the information regarding at least one item among the plurality of items. The processing unit associates the position information with the information regarding the item which is displayed in the second display area and whose two-dimensional position has been specified.

### Aspect 3

According to Aspect 3, in the information processing apparatus of Aspect 2, the creation unit creates the display screen that displays an indication image in the first display area based on a trained model and the information regarding the item displayed in the second display area. The indication image indicates a candidate two-dimensional position that is a candidate for the two-dimensional position. The trained model has been trained using training data including the information regarding the item and the two-dimensional image.

### Aspect 4

According to Aspect 4, in the information processing apparatus of any one of Aspects 1 to 3, the processing unit associates the information regarding the item with a partial image of the two-dimensional image at the two-dimensional position.

### Aspect 5

According to Aspect 5, in the information processing apparatus of any one of Aspects 1 to 4, the creation unit creates the display screen that displays, in the second display area, an identification image indicating that the information regarding the item and the position information have been associated with each other.

### Aspect 6

According to Aspect 6, in the information processing apparatus of any one of Aspects 1 to 5, the creation unit creates the display screen that displays a first identification image in the second display area, and creates the display screen that displays a second identification image in the second display area. The first identification image indicates that the information regarding the item and the position information have been associated with each other based on the two-dimensional position specified by a user. The second identification image is different from the first identification image and indicates that the information regarding the item and the position information have been associated with each other based on the two-dimensional position determined by a trained model trained using training data including the information regarding the item and the three-dimensional information.

### Aspect 7

According to Aspect 7, the information processing apparatus of any one of Aspects 1 to 6 further includes a display control unit and an acceptance unit. The display control unit displays the display screen on a display. The acceptance unit receives a specification of the two-dimensional position on the two-dimensional image displayed in the first display area.

### Aspect 8

According to Aspect 8, an information processing method performed by an information processing apparatus includes creating a display screen including a first display area that displays a two-dimensional image aligned with three-dimensional information and a second display area that displays information regarding an item, associating the information regarding the item displayed in the second display area with position information indicating a three-dimensional position of the item in the three-dimensional information, the three-dimensional position corresponding to a two-dimensional position specified on the two-dimensional image, and storing the information regarding the item and the position information associated with each other.

### Aspect 9

According to Aspect 9, a program causes a computer to function as a creation unit, a processing unit, and a storage control unit. The creation unit creates a display screen including a first display area that displays a two-dimensional image aligned with three-dimensional information and a second display area that displays information regarding an item. The processing unit associates the information regarding the item displayed in the second display area with position information indicating a three-dimensional position of the item in the three-dimensional information. The three-dimensional position corresponds to a two-dimensional position specified on the two-dimensional image. The storage control unit stores, in a storage unit, the information regarding the item and the position information associated with each other by the processing unit.

### Aspect 10

According to Aspect 10, an information processing system includes the information processing apparatus of Aspect 1, and a terminal apparatus communicably connected with the information processing apparatus. The information processing system also includes a creation unit, a processing unit, and a storage control unit. The creation unit creates a display screen including a first display area that displays a two-dimensional image aligned with three-dimensional information and a second display area that displays information regarding an item. The processing unit associates the information regarding the item displayed in the second display area with position information indicating a three-dimensional position of the item in the three-dimensional information. The three-dimensional position corresponds to a two-dimensional position specified on the two-dimensional image. The storage control unit stores, in a storage unit, the information regarding the item and the position information associated with each other by the processing unit.

1. An information processing apparatus comprising circuitry configured to:
create a display screen including:
a first display area that displays a two-dimensional image aligned with three-dimensional information; and
a second display area that displays information regarding an item;
associate the information regarding the item displayed in the second display area with position information indicating a three-dimensional position of the item in the three-dimensional information, the three-dimensional position corresponding to a two-dimensional position specified on the two-dimensional image; and
store, in a memory, the information regarding the item and the position information associated with each other.

2. The information processing apparatus according to claim 1,
wherein the item includes a plurality of items, and
the circuitry is configured to:
create the display screen that displays, in the second display area, the information regarding at least one item among the plurality of items; and
associate the position information with the information regarding the item which is displayed in the second display area and whose two-dimensional position has been specified.

3. The information processing apparatus according to claim 2, wherein the circuitry is configured to create the display screen that displays an indication image in the first display area based on a trained model and the information regarding the item displayed in the second display area, the indication image indicating a candidate two-dimensional position that is a candidate for the two-dimensional position, the trained model having been trained using training data including the information regarding the item and the two-dimensional image.

4. The information processing apparatus according to claim 1, wherein the circuitry is configured to associate the information regarding the item with a partial image of the two-dimensional image at the two-dimensional position.

5. The information processing apparatus according to claim 1, wherein the circuitry is configured to create the display screen that displays, in the second display area, an identification image indicating that the information regarding the item and the position information have been associated with each other.

6. The information processing apparatus according to claim 1, wherein the circuitry is configured to:
create the display screen that displays, in the second display area, a first identification image indicating that the information regarding the item and the position information have been associated with each other based on the two-dimensional position specified by a user; and
create the display screen that displays, in the second display area, a second identification image different from the first identification image and indicating that the information regarding the item and the position information have been associated with each other based on the two-dimensional position determined by a trained model trained using training data including the information regarding the item and the three-dimensional information.

7. The information processing apparatus according to claim 1, wherein the circuitry is configured to:
display the display screen on a display; and
receive a specification of the two-dimensional position on the two-dimensional image displayed in the first display area.

8. An information processing system comprising:
the information processing apparatus according to claim 1; and
a terminal apparatus communicably connected with the information processing apparatus.

9. An information processing system comprising:
circuitry configured to:
create a display screen including:
a first display area that displays a two-dimensional image aligned with three-dimensional information; and
a second display area that displays information regarding an item; and
associate the information regarding the item displayed in the second display area with position information indicating a three-dimensional position of the item in the three-dimensional information, the three-dimensional position corresponding to a two-dimensional position specified on the two-dimensional image; and
a memory that stores the information regarding the item and the position information associated with each other.

10. An information processing method comprising:
creating a display screen including:
a first display area that displays a two-dimensional image aligned with three-dimensional information; and
a second display area that displays information regarding an item;
associating the information regarding the item displayed in the second display area with position information indicating a three-dimensional position of the item in the three-dimensional information, the three-dimensional position corresponding to a two-dimensional position specified on the two-dimensional image; and
storing, in a memory, the information regarding the item and the position information associated with each other.

11. A non-transitory recording medium storing a plurality of instructions which, when executed by one or more processors, causes the one or more processors to perform an information processing method comprising:
creating a display screen including:
a first display area that displays a two-dimensional image aligned with three-dimensional information; and
a second display area that displays information regarding an item;
associating the information regarding the item displayed in the second display area with position information indicating a three-dimensional position of the item in the three-dimensional information, the three-dimensional position corresponding to a two-dimensional position specified on the two-dimensional image; and
storing, in a memory, the information regarding the item and the position information associated with each other.
